(19) United States
(12) Patent Application Publication
(10) Pub. No.: US 2022/0232262 A1
(43) Pub. Date: Jul. 21, 2022

(54) MEDIA SYSTEM AND METHOD OF GENERATING MEDIA CONTENT

(71) Applicant: Sounderx Limited, London (GB)

(72) Inventor: Paul Arthur Nicholson, Salisbury (GB)

(21) Appl. No.: 17/633,815

(22) PCT Filed: Aug. 12, 2020
(86) PCT No.: PCT/GB2020/051919

§ 371 Date: Feb. 8, 2022

(30) Foreign Application Priority Data
Aug. 13, 2019 (GB) 1911585.6

(51) Int. Cl. H04N 21/2187; H04N 21/854; H04N 21/2368; H04N 21/233

(52) U.S. Cl. CPC H04N 21/2187; H04N 21/233; H04N 21/2368; H04N 21/854

(57) ABSTRACT

A method and system for generating media content comprising synchronised video and audio components in which media content is captured using a camera function of a user device to generate media content having a captured video component and a captured audio component corresponding to a speaker output. An audio signal is transmitted corresponding to an audio signal input to the speaker; the wirelessly transmitted audio is synchronised with the captured video component and/or captured audio component of the captured media content to generate combined media content.

During a live performance such as a music concert, sports event, show or festival, a live sound mixing console receives various inputs from the performers on stage (from microphones, instrument pick ups, etc.) and a sound engineer operates the mixing console to provide the sound that is heard by the audience via speakers. Mixing consoles have numerous controls, such as equalization and volume controls and controls for various effects that may be mediated by plug-in software modules. Where a live performance is to be recorded, typically audio streams are passed from the mixing console to a recording device or digital audio workstation (DAW) for storing on a computer-readable storage device.

Over the last decade or so, the proliferation of lightweight handheld electronic devices and improvements in camera technology has changed photography, videography and communications.

Further, with increasing trends towards visual-based social media, numerous photo sharing applications have become popular and video continues to gain traction, with live streaming video being a current trend.

Video of live performances is often streamed or recorded and shared on social media by audience members using their mobile telephones or similar devices. The video and audio quality of such recordings is often fairly poor because although modern smartphones typically have built-in (internal) microelectromechanical systems (MEMS) microphones that deliver high performance for their size, they are usually optimised for telephone communication and recording speech. Such microphones tend to have limited dynamic range and are therefore not ideal for recording music or ambient noise. This is particularly apparent in large venues or festivals—and depending on where an audience member is located with respect to the stage and speakers.

External microphones or other wearable transducers connectable to a mobile telephone to improve the sound captured by the smartphone are known in the art and offer one solution to the problem. However, these require additional hardware and may not provide high quality audio.

It would be desirable to provide an improved media system for live performances.

One aspect of the invention provides a method of generating media content comprising synchronised video and audio components comprising:

capturing media content using a camera function of a user device to generate media content having a captured video component and a captured audio component;

the captured audio component corresponding to audio output by a remote speaker;

wirelessly transmitting to the user device an audio signal substantially corresponding to an audio signal input to the remote speaker; and

synchronising the wirelessly transmitted audio with the captured video component and/or captured audio component of the captured media content to generate combined media content in which the captured video component is synchronised with the wirelessly transmitted audio.

The method may comprise determining the location of at least one audio broadcast unit. This may be done using any GPS or assisted GPS-type technology and/or any unique identifier of the audio broadcast unit.

Optionally, the method comprises determining user device proximity to at least one audio broadcast device. The method may comprise determining user device proximity to a plurality of audio broadcast devices.

The method may comprise matching a user device location substantially to at least one audio broadcast device location.

In certain embodiments, the method comprises recording the audio signal substantially corresponding to an audio signal input to the remote speaker at the audio broadcast device.

Recording may be by an audio broadcast device.

Advantageously, the method optionally comprises optimising local storage of audio data at the audio broadcast device by automated commencement and cessation of recording.

Optionally, the method comprises listening to detect sound above a threshold level before commencing recording.

Advantageously, the method may comprise automatically commencing recording upon detecting sound above a threshold level. Recording may be automatically paused or otherwise cease when sound above the threshold level is not detected for a predetermined period of time.

The method may comprise temporarily storing recorded audio locally at the audio broadcast device.

Optionally, the recorded audio signal is transmitted to a server and subsequently deleted from the audio broadcast device.

The method optionally comprises listening to detect audio signals corresponding to sound above a predetermined threshold level.

The method optionally comprises recording audio signals.

The method optionally comprises generating and associating synchronisation data with the audio signals.

Optionally, the method comprises activating recording via a listening module upon detecting audio signals corresponding to sound above the predetermined threshold level.

Optionally, the method comprises deactivating the recording via a listening module upon failing to detect any audio signals corresponding to sound above the predetermined threshold level for a predetermined period of time.

In certain embodiments, the method comprises requesting synchronisation data upon detecting audio signals corresponding to sound above the predetermined threshold level.

This may be subsequent to a period of time of detecting no audio signals corresponding to sound above the predetermined threshold level. In this way, the method may comprise automatically requesting and associating synchronisation data with audio signals at the beginning of each set of a performance.

In certain embodiments, transmitting the audio signals with associated synchronisation data over the wireless network may comprise transmitting to one or more user devices and/or to a remote server.

Generation and association of synchronisation data with the audio signals may be by a signal processing device and/or user device periodically requesting synchronisation data from a server.

Optionally, the signal processing device comprises a location detection module. This may comprise a GPS receiver or other GPS functionality.

Optionally, the signal processing device comprises a unique identifier.

Optionally, the method comprises recording and storing audio signals at a signal processing device locally at the performance.

The method may comprise uploading audio signal recordings to an external server and subsequently deleting the uploaded audio signal recordings from local storage at the signal processing device.

Synchronisation data optionally comprises timing information.

Another aspect of the invention provides a method of generating media content comprising synchronised video and audio components comprising:

capturing media content using a camera function of a user device to generate media content having a captured video component and a captured audio component;

the captured audio component corresponding to audio output by a remote speaker;

wirelessly transmitting to the user device a video signal substantially corresponding to a video from a remote video camera module; and

synchronising the wirelessly transmitted video with the captured video component and/or captured audio component of the captured media content to generate combined media content in which the captured video and/or audio component is synchronised with the wirelessly transmitted video.

The captured media content may be user-generated content.

The remote speaker may be a loudspeaker of a public address system. The speaker may be at a location remote from the user device.

The captured audio component may be sound output by a remote speaker and captured by one or more transducers such as a user device microphone.

The audio output by a remote speaker may substantially correspond to the audio output by a mixing console.

The audio signal wirelessly transmitted to the user device may substantially correspond to an audio signal output by the mixing console.

The audio signal input to the remote speaker may comprise an amplified signal substantially corresponding to the audio signal wirelessly transmitted to the user device. This is because the signal from a mixing console may be amplified before being output to a speaker system.

The audio signal transmitted to the user device may comprise an audio signal substantially corresponding to an audio signal input to the remote speaker, which has been processed by a signal processor and optionally compressed.

The audio signal may be substantially the same as the audio signal input to the remote speaker or may be a modulated signal.

In one embodiment, transmitting to the user device comprises the user subsequently downloading the corresponding audio via the internet.

Optionally, the captured audio component corresponds to audio output by a remote speaker at a live event.

The captured video component may correspond to video of a live event or performance.

Optionally, the transmitted audio signal wirelessly transmitted to the user device substantially corresponds to an audio signal output from a mixing console.

The audio signal may be substantially the same as the audio signal output from the mixing console or may be a modulated signal.

The mixing console may be part of a public address system.

In certain embodiments, the method comprises generating synchronisation data.

Optionally, synchronisation data is generated at the audio broadcast device. Synchronisation data may be generated at the user device.

In certain embodiments, the audio broadcast device and/or user device request synchronisation data from a server.

The audio broadcast device and/or user device may periodically request synchronisation data from a server.

Optionally, the audio broadcast device requests synchronisation data from the server upon commencement of recording at the audio broadcast device.

Optionally, the user device requests synchronisation data from the server upon commencing capturing media content at the user device.

Synchronisation data may be generated by a clock synchronisation component such as from a system clock at the transmitter.

Synchronisation data may be generated at a remote server.

In certain embodiments, the method comprises wirelessly transmitting synchronisation data to the user device.

Optionally, the synchronisation data comprises timing information from a system clock function, which may comprise timestamp data. The synchronisation data may comprise metadata.

Optionally, the synchronisation data comprises clock synchronisation information to synchronise a clock function at the user device with a system clock function.

The clock synchronisation information may comprise calibration information for calibrating a clock function at the user device.

The clock synchronisation information may comprise a clock synchronisation signal.

Optionally, the system clock function comprises a system reference clock of a transmitter module.

In certain embodiments, the system clock function comprises a system reference clock at an application server. The application server may be a remote, cloud based server.

Optionally the synchronisation data is transmitted with the audio signal.

The audio signal may be modulated or otherwise processed by a signal processor to associate synchronisation data with the audio signal. The audio signal is optionally processed by a signal processor to compress signal data.

Optionally, the synchronisation data is transmitted as metadata.

The method may comprise transmitting a calibration signal for synchronising a clock function at the user device with a clock function at the networking module.

The method may comprise synchronising the wirelessly transmitted audio with the captured video component and/or captured audio component of the captured media content by synchronising a clock function at the user device with a clock function at the networking module.

Optionally, the clock function at the networking module comprises a reference system clock.

In certain embodiments, the synchronisation data comprises information for synchronising a clock function at the user device with a clock function at the networking module.

In certain embodiments, the synchronisation data comprises timestamp data from a software application server. Such data may be requested from the application server simultaneously and/or periodically by both the user device and the networking module.

Optionally, the synchronisation data comprises a combination of clock synchronisation data, waveform data and/or metadata.

In certain embodiments, the method comprises providing a networking module for creating a wireless network and wirelessly transmitting the audio signal to the user device over the wireless network, wherein the user device is connected to the wireless network via the networking module.

The networking module may comprise a wireless base station or small cell.

The networking module may comprise a wireless access point. The networking module may comprise a router. The networking module may comprise a transceiver.

In certain embodiments, the networking module facilitates wireless communication between the user device and the network and transmits the audio signal to the user device.

The networking module may receive the audio signal output from the mixing console.

In certain embodiments, the network comprises a private network.

The method may comprise generating synchronisation data at the networking module and wirelessly transmitting the synchronisation data to the user device.

In certain embodiments, the synchronisation data is transmitted with the audio signal.

Optionally, the clock function of a user device and the clock function of the networking module comprise substantially identical clock information.

The networking module may connect wirelessly to the software application executing on the user device connected to the network.

In certain embodiments, the transmitted audio is wirelessly transmitted to the user device substantially concurrently with the capturing of the media content by the user device.

As such, the transmitted audio may be wirelessly transmitted to the user device substantially in real time. This may be during capturing of the corresponding media content by the user device.

Optionally, the transmitted audio is synchronised with the captured video component and/or captured audio component of the captured media content to generate combined media content substantially concurrently with the capturing of the media content by the user device.

The method optionally comprises providing the generated media content to the user device. This may be provided substantially in real time to allow live video streaming.

In certain embodiments, the method comprises live streaming the combined media content. This may be via the internet and/or software application connected to a network.

The captured audio component of the captured media content may be combined with or substantially replaced by the wirelessly transmitted audio to generate the combined media content.

Optionally, the synchronising is performed by the user device executing a software application operable to synchronise the wirelessly transmitted audio with the captured video component and/or captured audio component of the captured media content.

In certain embodiments, generating combined media content is performed by a user device executing a software application operable to generate the combined media content.

In certain embodiments, wirelessly transmitting the audio signal to the user device is in response to a request from the user device.

Optionally, the request from the user device comprises a request to join a network, a user sign in to a software application and/or initiation of a video recording or live streaming session at the user device.

In certain embodiments, a combination of user audio and video with transmitted audio may be automatically optimised.

Optionally, the method comprises generating feedback data from the user device.

Another aspect of the invention provides a signal processing device for transmitting audio and/or video signals to, and receiving audio and/or video signals from, a wireless network comprising:

a receiver for receiving audio signals from a mixing console or audio workstation;

one or more processors configured to generate and associate synchronisation data with the audio signals, the one or more processors being coupled to a network module for providing a wireless network;

and a transmitter for transmitting the audio signals to one or more user devices over the wireless network.

An aspect of the invention provides a signal processing device for transmitting audio and/or video signals to, and receiving audio and/or video signals from, a wireless network comprising:

a receiver for receiving audio signals from a mixing console or audio workstation;

a listening module to detect audio signals corresponding to sound above a predetermined threshold level;

a recording module for recording audio signals;

one or more processors configured to generate and associate synchronisation data with the audio signals;

and a transmitter for transmitting the audio signals with associated synchronisation data over the wireless network.

Optionally, the listening module is configured to activate the recording module upon detecting audio signals corresponding to sound above the predetermined threshold level.

Optionally, the listening module is configured to deactivate the recording module upon failing to detect any audio signals corresponding to sound above the predetermined threshold level for a predetermined period of time.

In certain embodiments, the listening module is configured to prompt a request for synchronisation data upon detecting audio signals corresponding to sound above the predetermined threshold level.

This may be subsequent to a period of time of detecting no audio signals corresponding to sound above the predetermined threshold level. In this way, the device may automatically request and associate synchronisation data with audio signals at the beginning of each set of a performance.

Transmitting the audio signals with associated synchronisation data over the wireless network may comprise transmitting to one or more user devices and/or to a remote server.

The one or more processors may be configured to generate and associate synchronisation data with the audio signals by periodically requesting synchronisation data from a server.

Optionally, the signal processing device comprises a location detection module. This may comprise a GPS receiver or other GPS functionality. Optionally, the signal processing device comprises a unique identifier.

Optionally, the recording module is configured to record and store audio signals.

In certain embodiments, the signal processing device comprises a local storage management module.

The local storage management module may be configured to upload audio signal recordings to an external server and subsequently delete the uploaded audio signal recordings from local storage at the signal processing device.

Synchronisation data optionally comprises timing information.

In certain embodiments, the signal processing device comprises a server.

The user devices may comprise client devices.

In certain embodiments, the signal processing device comprises a clock synchronisation component for establishing a common time base between a master system clock and a clock function of the one or more user devices.

Optionally, the clock synchronisation component comprises an integral system clock.

In certain embodiments, the signal processing device comprises at least one antenna for communication over the wireless network.

The clock synchronisation unit may comprise a timecode generator for generating digital time data.

Optionally, the server unit comprises a GPS receiver for receiving data from a time server and/or for determining the location of the signal processing device.

The clock synchronisation unit may generate an actual time signal or synchronisation message.

In certain embodiments, the signal processing device comprises a transceiver. Optionally, the receiver, transmitter and network module are provided within a single housing unit.

The signal processing device may comprise a memory function for storing one or more programs executable by the one or more processors.

Optionally, the one or more programs comprise instructions to perform the method of the invention.

Another aspect of the invention provides a mixing console or audio workstation comprising the signal processing device.

Another aspect of the invention provides a public address system comprising the signal processing device.

Yet another aspect of the invention provides a system for generating media content comprising synchronised video and audio components comprising:

one or more user devices having a camera function for capturing media content to generate media content having a captured video component and a captured audio component;

the captured audio component corresponding to audio output by a remote speaker;

a transmitter configured to wirelessly transmit to the one or more user devices an audio signal substantially corresponding to an audio signal input to the remote speaker; and

at least one processor for synchronising the wirelessly transmitted audio with the captured video component and/or captured audio component of the captured media content to generate combined media content in which the captured video component is synchronised with the wirelessly transmitted audio.

One aspect of the invention provides a system for generating media content comprising synchronised video and audio components comprising:

one or more user devices having a camera function for capturing media content to generate media content having a captured video component and a captured audio component;

the captured audio component corresponding to audio output by a remote speaker;

a signal processing device configured to wirelessly transmit an audio signal substantially corresponding to an audio signal input to the remote speaker; and

at least one processor for synchronising the wirelessly transmitted audio with the captured video component and/or captured audio component of the captured media content to generate combined media content in which the captured video component is synchronised with the wirelessly transmitted audio.

Optionally, the signal processing device comprises a receiver for receiving audio signals from a mixing console or audio workstation.

Optionally, the signal processing device comprises a listening module to detect audio signals corresponding to sound above a predetermined threshold level.

Optionally, the signal processing device comprises a recording module for recording audio signals.

Optionally, the signal processing device comprises one or more processors configured to generate and associate synchronisation data with the audio signals.

Optionally, the signal processing device comprises a transmitter for transmitting the audio signals with associated synchronisation data over the wireless network.

Optionally, the listening module is configured to activate the recording module upon detecting audio signals corresponding to sound above the predetermined threshold level.

Optionally, the listening module is configured to deactivate the recording module upon failing to detect any audio signals corresponding to sound above the predetermined threshold level for a predetermined period of time.

In certain embodiments, the listening module is configured to prompt a request for synchronisation data upon detecting audio signals corresponding to sound above the predetermined threshold level.

This may be subsequent to a period of time of detecting no audio signals corresponding to sound above the predetermined threshold level. In this way, the device may automatically request and associate synchronisation data with audio signals at the beginning of each set of a performance.

Transmitting the audio signals with associated synchronisation data over the wireless network may comprise transmitting to one or more user devices and/or to a remote server.

The one or more processors may be configured to generate and associate synchronisation data with the audio signals by periodically requesting synchronisation data from a server.

Optionally, the signal processing device comprises a location detection module. This may comprise a GPS receiver or other GPS functionality.

Optionally, the signal processing device comprises a unique identifier.

Optionally, the recording module is configured to record and store audio signals.

In certain embodiments, the signal processing device comprises a local storage management module.

The local storage management module may be configured to upload audio signal recordings to an external server and subsequently delete the uploaded audio signal recordings from local storage at the signal processing device.

Synchronisation data optionally comprises timing information.

The system may comprise a software application executing on the one or more user devices to perform the synchronising of the wirelessly transmitted audio with the captured video component and/or captured audio component of the captured media content.

The system may comprise an application server configured to perform the synchronising of the wirelessly transmitted audio with the captured video component and/or captured audio component of the captured media content.

Yet another aspect of the invention provides a system for generating media content comprising synchronised video and audio components comprising:

one or more user devices having a camera function for capturing media content to generate media content having a captured video component and a captured audio component;

the captured audio component corresponding to audio output by a remote speaker;

a transmitter configured to wirelessly transmit to the one or more user devices an audio and/or video signal, wherein the audio signal substantially corresponds to an audio signal input to the remote speaker and the video signal comprises video data from a remote video source; and

at least one processor for synchronising the wirelessly transmitted audio and/or video with the captured video component and/or captured audio component of the captured media content to generate combined media content in which the captured video component is synchronised with the wirelessly transmitted audio and/or video.

In certain embodiments, the system comprises a mixing console configured to transmit an audio signal to the transmitter.

A clock synchronisation component may be configured to generate synchronisation data. In certain embodiments, the transmitter comprises the clock synchronisation component for establishing a common time base between a master system clock and a clock function of the one or more user devices.

Synchronisation data may be generated by a clock synchronisation component such as from a system clock at the transmitter.

The remote video source may be at a different location or position from the user device camera. The remote video may capture video content corresponding to the same live performance as the captured video component.

In certain embodiments, the one or more user devices comprises a software application and a processor for executing the software to communicate with the server device of the invention.

Optionally, the transmitter comprises a networking module for creating a wireless network.

The one or more user devices may be connected to the wireless network via the networking module.

The networking module may comprise a wireless base station or small cell. The networking module may comprise a wireless access point. The networking module may comprise a transceiver.

The at least one processor may be a personal electronic device processor.

The at least one processor may comprise a software application processor of a mobile telephone.

The at least one processor for synchronising the wirelessly transmitted audio may comprise a processor of the signal processing device of the invention.

The system may optionally comprise one or more of: a mixing console, an audio workstation, a loudspeaker, an amplifier, a transducer, a user device, and one or more wireless access points.

The system may comprise a plurality of the networking modules. The networking modules may communicate with each other over the network. The system may comprise a plurality of the user devices.

Another aspect of the invention provides a non-transitory computer-readable medium comprising computer-executable instructions which, when executed by one or more processors, cause the one or more processors to perform the method of generating media content.

Yet another aspect of the invention provides a wearable device configured to communicatively couple with one or more processors comprising instructions executable by the one or more processors, and wherein the one or more processors is operable when executing the instructions to perform the method of the invention.

### BRIEF DESCRIPTION OF THE DRAWINGS

In the Figures, which illustrate embodiments of the invention by way of example only:

FIG. 1 schematically illustrates an embodiment of the system of the invention.

FIG. 2 schematically illustrates an embodiment of the communication network environment of the invention.

FIG. 3 is a rear view of an embodiment of the server or broadcast unit of the invention.

FIG. 4 is a flow diagram illustrating an embodiment of the method of the invention.

FIG. 5 is a schematic illustration of an embodiment of the system of the invention.

FIG. 6 is a flow diagram illustrating an embodiment of the method of the invention.

FIG. 7 is a flow diagram illustrating an embodiment of the method of the invention.

### DETAILED DESCRIPTION

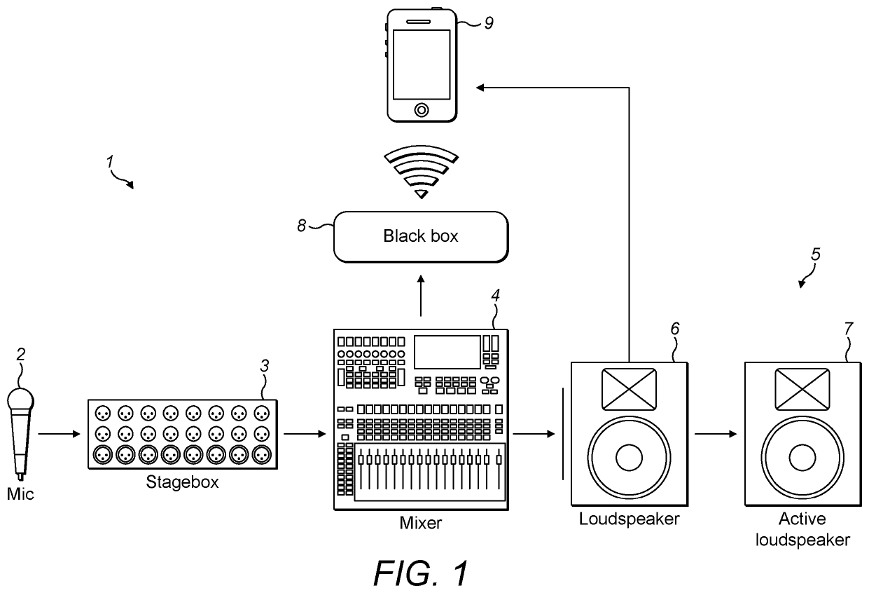

FIG. 1 shows an example of a sound or PA (public address) system 1 for a live music event in which audio from performers and musicians on stage is picked up by one or more transducers 2 (such as microphones, instrument pick-ups, outputs of keyboards and other equipment). Crowd noise from the audience may also be picked up by stage microphones. Signals from the transducers 2 are sent by cable or wirelessly to a mixing console 4 via a stagebox interface 3.

The mixing console (or “mixing desk”) 4 may process analogue or digital signals. Each audio signal is directed to an input channel of the mixing console 4 and these signals are processed and combined to provide an output signal delivered to the speaker system 5 via an output channel.

Audio signal processing at the mixing console 4 may include altering signals to change, for example, relative volumes, gain, EQ (equalization), panning, mute, solo and other onboard effects.

The master output mix created at the mixing console 4 is amplified and transmitted to the audience via the speaker system 5. One or more auxiliary output mixes may also be directed to the performers on stage via stage monitors. As shown in FIG. 1, the speaker system 5 includes an active subwoofer 6 and active loudspeaker 7. Alternative arrangements may include separate amplifiers and speakers.

The mixing console 4 may further comprise or be connected to a recording device such as a digital audio workstation (DAW) for further processing and recording. Mixing consoles are commonly connected to one or more outboard processors such as digital signal processing (DSP) boxes (e.g., noise gates and compressors), each providing individual functionality to increase the overall system possibilities for sounds and audio manipulation.

The signal chain is indicated by the arrows in FIG. 1, which schematically illustrate the audio signal from the mixing console 4 being transmitted via the broadcast unit 8 to the user device 9.

As indicated, a corresponding audio signal (i.e., comprising the same audio information or the same “mix”) is also transmitted from the mixing console to the loudspeaker 7, and the audio output from the loudspeaker 7 is picked up by the user device microphone. In other words, the signal input to the loudspeaker 7 is substantially the same as the signal input to the broadcast unit 8 and the same master output audio mix is output to the user device via the loudspeaker and via the broadcast unit 8.

Referring to FIG. 1, the system 1 of the invention comprises a communication interface module which comprises a server (“local server”). This “broadcast unit” 8 is connected (either wirelessly or via one or more cables) to a mixing console 4. In certain embodiments, the broadcast module is integral with the mixing console 4, speaker system, or other audio processing or network communication hardware.

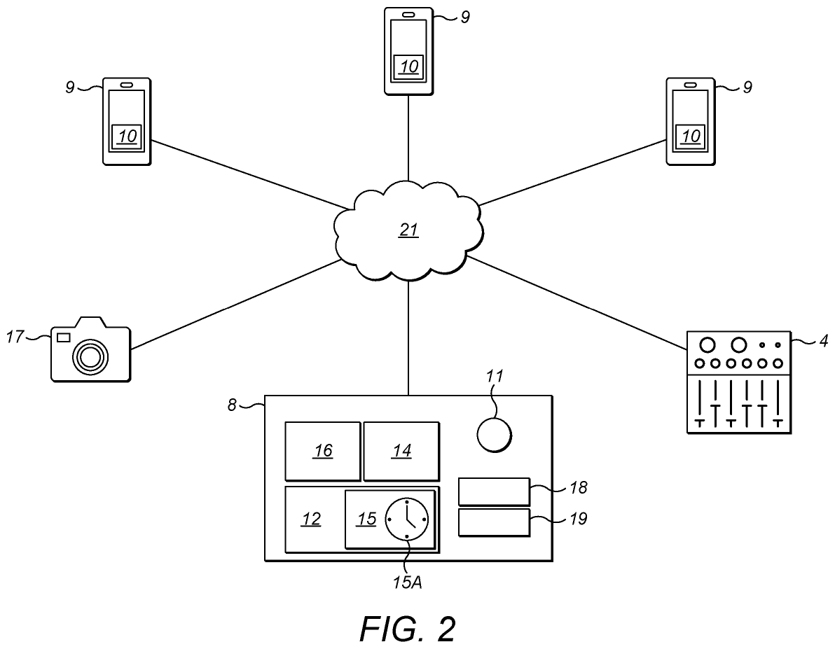

As illustrated in further detail in FIG. 2, the broadcast unit 8 comprises a receiver 18 for receiving an audio signal input from the mixing console 4, which corresponds to the master output audio mix such that it includes substantially the same audio or sound wave information as the master audio mix. At the broadcast unit 8, the audio signal is automatically time stamped and formatted (e.g., compressed into a format that can be read by media players).

The broadcast unit 8 further comprises a transmitter 19 to wirelessly transmit the master audio mix signal (which may be a modulated master audio mix signal) to a remote server for processing or directly to one or more portable electronic user devices 9, such as mobile telephone communications devices, smartphones, smart watches and other mobile video devices such as wearables having video functionality.

A modulated signal includes a signal that has one or more of its characteristics set or changed in such a manner as to encode information, instructions, data, etc., in the signal.

In certain embodiments, a user device 9 may comprise any portable electronic device such as a tablet computer, a laptop, a personal digital assistant, a wearable smart watch, headgear or eyewear or other similar device with similar functionality to support a camera function and optionally transfer or stream data wirelessly to a router or cellular network. In certain embodiments, the user device 9 may comprise a plurality of connected devices, such as a wearable bracelet, glasses or headgear communicatively coupled to another portable electronic device having a user interface, such as a mobile telephone.

The user device 9 may comprise one or more processors to support a variety of applications, such as one or more of a digital video camera application, a digital camera application, a digital music player application and/or a digital video player application, a telephone application, a social media application, a web browsing application, an instant messaging application, a photo management application, a video conferencing application, and an e-mail application.

In one embodiment, the user device 9 has a front-facing camera module including a camera lens and image sensor to capture photographs or video and a rear-facing second camera module. The user device 9 further comprises an audio input-output (I/O) system, processing circuitry including an application processor, a wireless communication processor and a network communication interface. It generally also includes software stored in non-transitory memory executable by the processor(s), and various other circuitry and modules. For example, the application processor controls a camera application that allows the user to use the mobile device 9 as a digital camera to capture photographs and video.

Mobile video devices such as smartphones also usually include an operating system (OS) such as iOS®, Android®, Windows® or other OS. A GPS module determines the location of the mobile device 9 and provides data for use in applications including the camera (e.g., as photograph/video metadata).

FIG. 2 illustrates an exemplary network environment in which one or more users capture a video of a live performance with a software application 10 executing on the user's mobile video device 9. Each user will typically capture a different short section of a performance, unique to the user in terms of camera angle, microphone audio (which may depend on user position in a venue), start/stop times or length of capture. Users also commonly include video footage of themselves and/or other audience members.

A real-time video stream may be generated by each user and broadcast live, e.g., via a social media platform, which may be a pre-existing social media platform or a bespoke video-sharing platform forming part of the system 1.

The mobile device 9 is connected to a network 21, for example, a wireless area network or Wi-Fi, which may comprise or be part of one or more local area networks (WLANs) provided by a wireless access point 11 on the broadcast unit 8, which serves as both wireless base station and transceiver for media signal processing and transmission. Communication protocols such as transmission control protocol TCP/IP or user datagram protocol (UDP/IP) are utilised. Other types of suitable wireless communications networks are envisaged and may be utilised. These include any other suitable communication networks, protocols, and technologies known in the art, such as Wi-Fi, 3G, 4G, WiMAX, wireless local loop, GSM (Global System for Mobile Communications), wireless personal area networks (PAN), wireless metropolitan area networks (MAN), wireless wide area networks (WAN), networks utilising other radio communication, Bluetooth and/or infrared (IR).

In the illustrated embodiment, the network 21 is a private network and the broadcast unit 8 of the network system communicates with the software application 10 executing on the user device 9 to identify the user device 9. An authorisation module 16 verifies any necessary associated authorisations for receiving high definition audio from the mixing console 4 at the device 9. Such authorisation may include identification of a user ID, media access control (MAC) address, or any other suitable client device identifier. Optionally, authorisation data may comprise event ticket and/or GPS information. A virtual firewall (not shown) provides a secure location which users cannot access without agreeing to terms and conditions of the software application 10. Separated architecture using multiple hard drives may be utilised for firewall separation of application and user access. The network 21 may provide an encrypted communication session for authenticated users generating and receiving media data over the network.

Joining of the private network 21 may initiate software execution at the user device 9 to perform time stamping and other in-app video functions, as well as user device requests for HD audio (and/or high quality video) signals from the server. The private network 21 may also provide access to/from the Internet to allow live streaming and video uploads to social media sites.

Within the CMS it is possible to manage active broadcast units. Broadcast unit unique ID, latitude and longitude data is used to verify each broadcast unit request. If this information is not verified, any attempt to push data to the application server will be rejected.

The audio signal received at the broadcast unit 8 from the mixing console 4 is processed by a processing module 14 to generate and/or associate various data and/or metadata with the audio signal or stream. Data (and/or metadata) may be associated with the signal by modulating the audio wave and/or broadcast as chirps with the audio wave. Such data or metadata may, for example, comprise timing information, frequency information, such as frequency components of soundwave or spectrogram peaks, digital audio fingerprint information, other waveform information, click tracks, other synchronisation pulses, and/or other values and data related to the audio signal. Data may be encoded into the audio signal and decoded (demodulated) by a processor at the receiving user device 9.

A synchronisation module 12 provides synchronisation information, which may include any of this data for synchronising the high definition audio with the video stream captured by a user on the user device 9. An enhanced video stream comprising the associated high definition audio from the mixing console 4 is generated and may be provided to a social media application for sharing via the internet (either by upload, live streaming, etc.) and/or saved in memory on the user device 9, or cloud location (which may include a secure storage facility provided via the software application 10).

The synchronisation module 12 comprises a clock sync component 15 that utilises a system clock 15A associated with the broadcast unit 8 (a broadcast unit internal clock or server clock), to establish a common time base between the master system clock 15A of the broadcast unit server 8 and a plurality of user devices 9, each having their own clock function (which may be supplied by the original equipment manufacturer via default device applications or settings, or may be an alternative clock function, such as a clock function provided by the software application 10).

In one embodiment, the system clock 15A comprises a hardware reference or primary time server clock and utilises a network time protocol (NTP) type synchronisation system. The broadcast unit 8 may comprise a GPS antenna for receiving timing signals, which can be transmitted to user devices 9.

The clock sync component 15 of the synchronisation module 12 is configured to generate a timecode/timestamp, which can be utilised for correlation with the device clock function corresponding to the timing of video captured at the user device 9.

The clock sync component 15 is configured to synchronise the time at the master system clock 15A with the clock at one or more user devices 9 (which may function as a master and slave type configuration). This includes a clock component of the application 10 executing on the user device 9 and/or accessing and calibrating another clock application or widget on the user device 9, for example the manufacturer-provided operating system clock function.

In another embodiment, the clock functions may be synchronised by the application 10 executing on the user device 9, providing instructions for the user device 9 to query another time server via the wireless access point 11, which is the same as a time server providing a timing signal to the system clock 15A, such as a GPS satellite-based time server.

An authenticated user device may be prompted to query a time server (either the system clock 15A or other remote time server) at start-up of the application 10, request to join the private network, or a video session. The user device may reset /synchronise its internal clock, synchronise with an application clock and/or calculate a time differential between one or more user device clocks and the system clock 15A and calculate any offset for synchronisation of audio and video, taking into account signal transmission and arrival times.

The timing information generated by the synchronisation module 12 of the unit 8 may comprise a calibration (or clock synchronisation) signal or metadata timecode. This is transmitted together with the audio signal to the user device 9. The application 10 executing on the user device 9 utilises timestamp data to synchronise high definition audio transmitted to the user device with video (and optionally audio) captured by the user using the user device 9. In certain embodiments, real-time synchronisation provides live streaming functionality such that the user may live stream the video substantially at the same time as they are recording the video footage, combined with the associated HD audio received from the mixing console 4 via the broadcast unit 8.

In the illustrative embodiment shown in FIG. 2, the synchronisation module 12, clock sync component 15, system clock 15A, authorisation module 16 and processing module 14 are housed within the broadcast unit 8. It will be appreciated that any of these modules and/or processing functions performed by these modules may alternatively be performed at a remote server in communication with the broadcast unit 8.

The user device 9 video function also utilises one or more built-in device microphones and captures ambient audio transmitted from the speaker system along with the captured video.

The HD audio signal received at the user device from the broadcast unit 8 can be further synchronised with the user video by algorithmic comparison and matching of characteristics of the audio signal from the device microphone (such as waveform alignment/audio fingerprinting) and the audio signal (and associated metadata) received from the broadcast unit 8. Synchronisation may be achieved and/or refined using a combination of algorithmic comparison of signals (and optionally metadata) and timing information from the clock sync module 15. In certain embodiments, a synchronisation pulse (from a GPS-based time server or otherwise) accurate to microsecond levels may be output from the broadcast unit 8 to the user device 9 with the media signal. Click track data from the stage audio may also be included in the broadcast to aid audio synchronisation.

The synchronisation module 12 provides synchronisation information such that data may be aligned by the application 10 at the user device 9. Any time differences between the arrival time of the signal from the broadcast unit 8 and the audio transduced by a microphone of the user device 9 are automatically adjusted and digital audio fingerprints and/or other metadata may be used to overlay the audio transmitted from the broadcast unit to the user video, which may require a few milliseconds of adjustment.

In certain embodiments, the synchronisation of audio and video may be performed by one or more processors at the broadcast unit 8 communicating with the user device 9. Alternatively or in addition, synchronisation of audio and video may be performed at a remote server.

In certain embodiments, the system comprises a server pool comprising a plurality of local and/or remote servers, which may include cloud-based servers. An application server or CMS is responsible for communicating with the software application on the user device. A storage server stores all uploaded HD audio and user media files. Storage usage is actively monitored and increased as necessary. A database server stores all application and user data. Data is encrypted at rest and the encryption keys are stored separately. A load balance determines which of a number of application servers has capacity to handle each current request and distributes the load accordingly. The system is able to handle a high volume of simultaneous requests for information in addition to supporting a high number of concurrent users.

The application server(s) are configured to make use of compression to serve content. This allows the server to compress data before it is sent to a user device, helping to keep load times low without compromising the content quality. The data is automatically uncompressed on the user's device. Additionally, where applicable, the application server(s) cache requests to minimise the amount of work required by the server to complete the request.

Server usage is monitored and adjusted automatically, for example by assigning more resources to the existing servers, shutting down unnecessary services on the server to free up resources, or employing an additional server to share the load.

In certain embodiments, signal processing may be performed at a remote server and as such, the broadcast unit 8 may transmit high definition audio signals to a remote server (which may be cloud-based) and processing may be performed at the server, such that both the broadcast unit and user device request synchronisation data from the same remote application server.

To ensure accurate synchronisation, both the App executing on a user device and the broadcast unit 8 request the current timestamp from the application server at regular intervals. This information is stored against the recorded media and used to clip the audio files to the correct length. The timestamp is to the nearest millisecond, which is important for accurate synchronisation. Thus utilising the clock function of a mobile telephone may be less reliable.

The system takes the start time of the video and checks that it falls within the start and end times of the audio file. If it does, it will then cut the audio at the video start and end times.

The user may be sent a notification and the new audio clip can then be streamed to the user's device in synchronisation with the video. Synchronisation may be performed at the server or at the user device. The system also generates a version of the video with the original audio replaced with the broadcast unit audio for sharing on social platforms. The audio on these clips has a short fade in/out so they do not immediately start at maximum volume.

Upon a user pressing the record button within the App, a request is sent to the application server to get the current timestamp. Once a video has been captured, the user is presented with two options—Add to Queue (upload) or Save Video to Camera Roll. The App will prompt users to enable location services while in use. This will allow the App to recognise where the user is placing them at an event/show and proximity to a broadcast unit 8 and obtain certain other data. When the audio broadcast unit is automatically prompted to commence recording by listening and detecting sound, it also requests a current timestamp from the server. User devices and the broadcast unit periodically request timestamp information from the server during recording, such that timestamp information is accurate to the nearest millisecond.

Waveform or audio fingerprint data from user-generated video/audio may also be compared with data received with the HD audio signal to provide an assessment of the quality of the user-generated audio from the user device microphone. This can be used to automatically optimise any combination of user-generated audio and HD audio wirelessly received from the mixing console 4. This may be done by algorithmically adjusting volume levels or other components of the signal to provide an optimised combined audio matched to the user-generated video.

The application 10 may provide instructions such that the headphone output and/or speaker output of the user device 9 is muted automatically during synchronisation of the received audio signal with the user-generated video. Thus, the user does not hear the received HD audio during the live performance, even if live streaming the video recording.

As illustrated in FIG. 2, in certain embodiments the system 1 of the invention may comprise one or more camera modules 17 remote from the user devices 9. The camera module 17 provides a high quality video signal, which may be processed by the system in a similar fashion to the HD audio signal. The broadcast module 8 receives audio data from the camera module 17 and transmits it to user devices 9, together with synchronisation information, such that user-generated video can be combined and enhanced with high quality video from the camera module 17. In certain embodiments, the camera module 17 comprises a camera module clock (not shown), which is synchronised with the system clock 15A, and timecode information transmitted to a user device 9 may be provided by the camera module clock, the system clock 15A, or both.

In certain embodiments, a user requests transmission of a video signal from a video source (camera module 17) to a user device 9 as an alternative, or in addition to an audio signal. The video may correspond to a video displayed on a screen at the live event, such as video of the performers on stage, or video that is not displayed at the event.

In a similar system to the audio transmission, the video signal is input to the broadcast unit 8 in addition to the audio signal from the mixing console 4. The video signal is automatically time stamped utilising a system clock 15A and is formatted, e.g., compressed into a format that can be read by media players of a user device 9. Transmission of video signals may utilise UDP/IP instead of TCP/IP. If both audio and video signals are received at the broadcast unit 8, software executing at the broadcast unit 8 provides functionality for combination of the HD audio and video data feeds and synchronisation before transmission to a user device 9. Video (and optionally additional audio) received at a user mobile video device 9 may be combined with (i.e., merged to varying degrees e.g., utilising a slider function—or otherwise utilised to provide enhanced user video) the user-generated video captured by the camera of the user device 9. Combination and optimisation of transmitted and user-generated video may be an automatic function provided in real time by the software application 10 executing on the user device for live streaming or it may be a function for post-event processing (optionally with subsequent video data download) by a user.

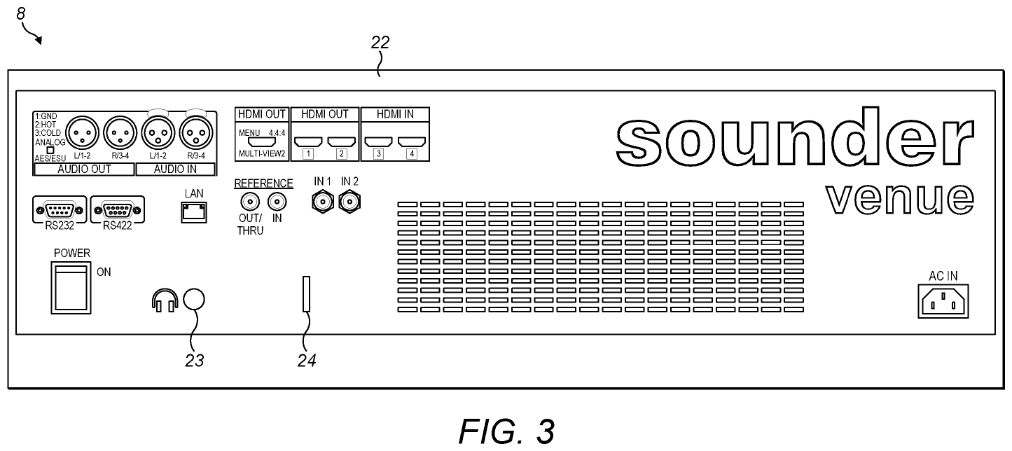

One illustrative embodiment of the broadcast unit 8 of the invention is shown in FIG. 3. The broadcast unit 8 comprises a processor, input/output system and communications circuitry.

This may comprise radio frequency (RF) transceiver circuitry and at least one antenna for receiving and transmitting digital signals. The unit 8 further includes a wireless access point (WAP) 11 to provide a closed local area network (which may be part of a wide area network).

An internal PC-based system clock 15A in the unit 8 provides a network synchronised time stamping service for software events, including message logs. The synchronised time accurate correlation of log files between the user device 9, software application 10 and broadcast unit hardware provides this functionality.

The WAP 11 provides additional information on users of the system, including logging the number of users, how much data is being used, collecting other user data such as behavioural data for storage, as well as generating time stamp correlations. Advantageously, the broadcast unit 8 has functionality to process and transmit audio data to a large number of user devices requesting HD audio. A plurality of broadcast units may be utilised in very large venues or festivals.

A feedback system may process and store data received from user devices 9 via the network and/or application. Feedback data may include information about the user and user behaviour, such as which sections of the performance the user recorded and/or streamed, which performers the user was most engaged with, which social networking sites the user uploaded video or streamed to and GPS information on where the user was located within the venue. The feedback system may further provide aggregated data such as parts of the performance in which video or user engagement peaked, user demographic etc.

The feedback data from the system 1 may be utilised to provide customised advertisements to the user, for example via the software application 10, which may be displayed to the user during the event or subsequently. For example, GPS information may provide information on whether a user is located in a premium seating location and advertisements may be customised to target premium customers.

Feedback data or other data received by the broadcast unit 8 may be utilised by the system to automatically adjust the bitrate for streaming. At the broadcast unit 8 there may be automatic adjustment of the bitrate (upscaling if necessary) to provide an HD audio feed to a maximum of 0 db. Transparent (musical) compression may be activated when −3 db is reached. There may also be automatic adjustment of signal from the mixing desk, e.g., amplification to compensate for any audio mix that may be at a low level.

In certain embodiments, the broadcast unit comprises a tamper proof secured housing 22 in a 3U rack mount format box and a motherboard with the relevant cards and connections at the front or rear side. The size of the box (housing 22), number of antennae, user access configurations (I/O system) etc. may be varied depending on the end use location and/or venue size. For example, arena, festival, theatre, stage or street locations. For larger locations/venues, the system 1 may require a plurality of broadcast units 8 at selected locations around or within the area.

In one embodiment, the broadcast unit 8 comprises a server in a rack mount platform installed in a transportable rack case. It has a dual hard drive system with a soft firewall between these (e.g., 1×Solid State Drive and 1×SATA Hard Drive). A four port Server CAT6 Card connects to the Wireless Access Point(s), network and other network devices. A 16 GB RAM 21″ monitor keyboard and mouse may also be installed in the system with a sliding rack shelf. Windows® and DANTE® Virtual Sound Card licences enable connection to the mixing desk 4. A slot enabling an upgrade facility may be included, for, e.g., multitrack output and recording via a Dante or similar industry standard digital interface. The unit 8 further comprises dual band 2.4 GHz and 5 GHz Wireless Access Points with a tripod system.

A sound engineer or other user may listen to audio at the broadcast unit 8, via a headphone output 23, and it may be possible to adjust the volume via a volume control. A signal output display 24 indicates correct function and transmission of signal(s).

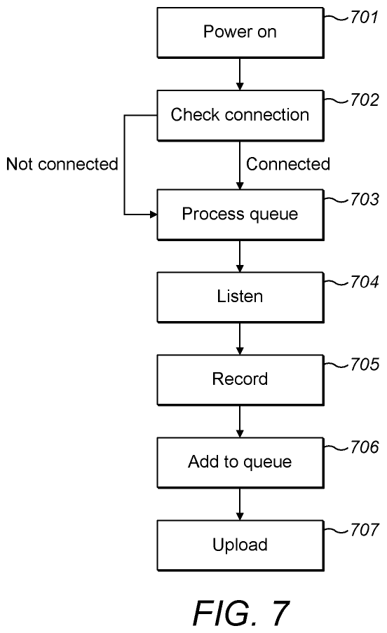

A recording facility at the broadcast unit 8 records and automatically deletes recordings data after a predetermined amount of time, e.g., 1 week (and/or once the recordings have been backed up to a main server) to free up local memory at the unit 8. An embodiment of a dynamic broadcast unit storage management module or system is described with reference to FIG. 7.

A system having a plurality of units 8, for example at a festival site, would be individually visible to a main server and cover a number of stage areas at different locations. In certain embodiments, any of the units 8 may send and receive signals to one or more other units 8.

In a further embodiment, the audio signal may be subsequently synchronised on demand with a video recording from the event at a time after the live event (i.e., not live during the event or performance). For example, video captured by the user device at the live event may be stored in memory on the user device or cloud location (and/or via the software application 10) for playback at a later time. The application 10 executing on the user device at the time of video capture associates the relevant timestamp data to the video data, which can be used to synchronise high definition audio to the video after the event. This provides functionality for downloading HD audio via the internet to be matched and accurately synchronised with a user video recording at any time after the event.

The audio received at the user device 9 from the mixing console 4 via the broadcast unit 8 can be stored separately (or be otherwise separable) from the user device microphone-captured audio. A user can therefore listen to the received audio or transduced audio, or a combination of both at user-adjustable relative volumes.

In certain embodiments, the application 10 provides functionality for adjusting various attributes of the sound, such as mixing and equalising the sound, adjusting the relative volumes of instruments, vocals, audio captured by the user video device microphone(s) and received audio. A virtual mixing console with graphic equaliser display (not shown) having sliders (faders) and other controls may be presented via a user interface such as the screen of the user device 9. The user's personalised media mix can be combined with the captured video and saved in memory and/or uploaded to social media. This function also provides customisable combination of user-generated video with high quality received video from the video module 17.

All recordings are accessible via a central library, displayed as a dynamic list, and additional recordings/data is loaded as the user scrolls. The user will be able to access a “cross-fader,” which will enable them to slide between the recorded audio and the matched high-quality sound. The high-quality, matched audio may be the default sound to every video recording. When playing back a recording the user can access an equalizer (EQ), enabling them to adjust the bass, mids and treble of a recording. The EQ settings will be saved to the user's library per recording and will be adjustable at any time during playback. Within the CMS it will be possible to view usage statistics through the Dashboard module. Data will be collected by the platform and visible through the Dashboard and may include: Device Type Operating System (iOS/Android), Active/Total User Numbers Average Recordings, Average Video Duration, Popular Artists, Popular Venues, Streams per Show/Venue/Artist.

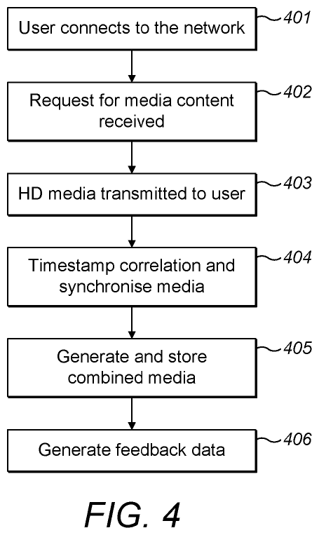

An embodiment of the method of the invention is illustrated in FIG. 4. At a step 401, an authenticated user connects to the private network. At 402, the user initiates video content generation and the server at broadcast unit 8 receives a request for HD audio and/or video from the user device, via the software application executing on the user device. At step 403, the HD media signal(s) are transmitted, together with synchronisation data to the user device. At 404, the HD media is algorithmically synchronised with the user-generated content using the synchronisation information to generate and store combined media content at 405, which may be live streamed, etc., by the user in real time. In this way, live event audio and video may be synchronised to a mobile telephone. At a step 406, feedback data is provided to the system.

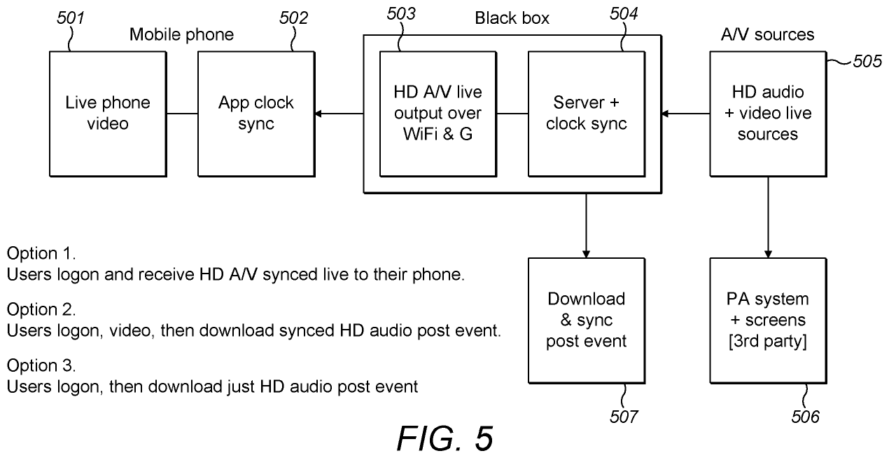

FIG. 5 schematically illustrates an embodiment of the system of the invention showing user device video block 501 and clock synchronisation block 502 at a mobile phone receiving a signal from the broadcast unit “black box”, having communications block 503 and a server block 504 with clock synchronisation component. Blocks 503 and 504 receive signals from audio and/or video sources 505, which is the substantially the same as signals transmitted to the PA System and optionally other remote screens 506. At block 507, a user is also able to download the audio/video and synchronisation data to enable synchronisation after the event.

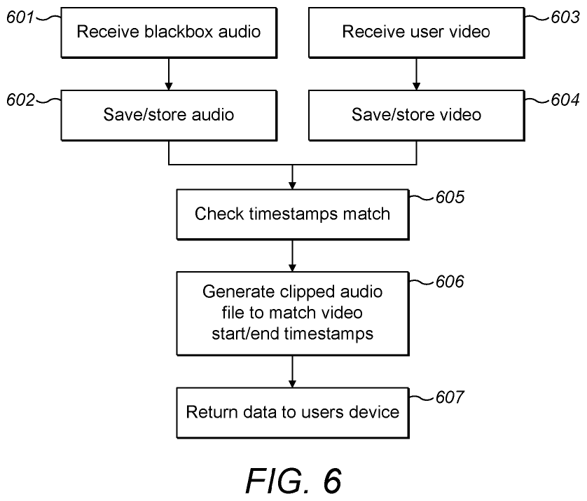

In an embodiment illustrated in FIG. 6, a user opens a software application (App) on the user device to capture a video event. Opening the application will send a request to a server (which may be a cloud-based server) with the user's location, to check whether they are currently at a recognised venue or show. The user location is matched to the broadcast unit 8 (not shown) location to determine which show the user is at. When the user starts to record video, the application executing on the user device will generate a timestamp by requesting current time from the server. Software executing at the broadcast device also generates timestamp information. At a step 601, the audio from the broadcast unit (not shown) “Blackbox Audio” is received at the server and saved/stored at 602. At a step 603, the timestamp and user recorded video is sent to the server for processing. When the user video is received at the server it is saved/stored at step 604.

At a step 605, timestamps from the application on the user device and the broadcast device are matched, to generate an audio file that matches user video start and end timestamps. To ensure an accurate synchronisation, both the App (user device) and the audio broadcast device request the current timestamp from the application server periodically at regular intervals.

In certain embodiments, audio to video matching is performed server-side. The server maintains a log of the physical location of the broadcast device(s) 8. This may be using device unique ID, manual log of location and/or GPS/assisted GPS data from the broadcast device. The broadcast device(s') location is matched with the user's location (through the App) in order to place the user at a particular venue/show/stage area. At large festival type events, where users may be moving around within a large area, this provides the advantage that a user can be matched to a particular performance at one of several stages by user proximity to a particular broadcast device or devices and/or by user network connection to a particular WAP. Furthermore, the broadcast device 8 may be easily disconnected/unplugged from an audio workstation or mixing console and utilised at another stage area if there is a change of location for a performance or change in schedule, etc.

Once the system has determined the authorised user is at an authorised performance, it checks for any audio matching the provided timestamps. The system takes the start time of the video file and checks that it falls within the start and end times of the High Definition audio file. If there is a match, the system generates high quality audio soundtrack at the video start and end times (step 606) and provides this to the user (step 607).

When the audio has been successfully matched, the user will also be able to play back user video with the high quality audio through the App. The user will be able to fade between the two audio streams—their own from their original audio recording with user video and the high quality audio from the broadcast unit. The system also generates a copy of the user's video with the audio replaced with the high quality audio from the mixing desk/broadcast unit adapted for sharing on social media platforms.

The broadcast unit 8 comprises software for listening, detecting and recording audio received via the broadcast unit audio input(s). The broadcast unit automatically loads/runs all required software on boot, enabling an audio engineer to simply plug it in and turn it on.

Each broadcast unit will have a unique identifier (e.g., Serial Number) assigned to it, which is used to associate each broadcast unit to a particular venue/performance and/or physical location. The unique ID also provides functionality to track usage (e.g., number of shows recorded at a particular location) and to prevent unauthorised devices from connecting to the application servers.

Where the system is utilising the venue network and a venue is unable to guarantee the broadcast unit access to an active internet connection, the software will maintain a queue of all recently recorded audio in order to keep track of audio that has been recorded but not yet uploaded. When the broadcast unit has access to the internet, the software will process the queue and upload it to the remote (or cloud based) application server.

FIG. 7 illustrates an embodiment of broadcast unit software lifecycle that may be executed at a local storage management module of the broadcast unit. At a step 701, when powered on and connected to an audio source such as a mixing desk, the broadcast unit will passively listen 704 for any sound from the performance (signal from audio input) over around −50 to −20 dB, preferably −30 to −40 dB and more preferably around −32 dB.

When a sound from the performance matches or exceeds this threshold, the broadcast unit will generate a timestamp and start recording a higher quality feed from the audio input at 705. This recording will continue until the broadcast unit hears nothing for around 5 minutes, after which, the high quality audio recording will be saved to a local storage queue 706 ready for upload to the server at 707 (which may be a remote/cloud based server).

As shown at step 702, if the broadcast unit 8 has an active internet connection, the high quality audio will be automatically processed 703 and uploaded to the server 707 and removed/deleted from the broadcast unit to give capacity for future recordings. If the broadcast unit does not have an active internet connection, the high quality audio will be added to an upload queue 706 until an active internet connection is available and upload can commence at 707.

Once a high quality recording has finished, the broadcast unit will begin listening for a sound again, ready to record.

At large events, the system may utilise a plurality of broadcast units at predetermined locations around a venue. The broadcast units may be in communication via the network in order to distribute load or storage across the plurality of broadcast units.

It will be appreciated that embodiments of the invention may be implemented in hardware, one or more computer programs tangibly stored on computer-readable media, firmware, or any combination thereof. The methods described may be implemented in one or more computer programs executing on, or executable by, a programmable computer, including any combination of any number of the following: a processor, a storage medium readable and/or writable by the processor (including, for example, volatile and non-volatile memory and/or storage elements), an input device, and an output device. Any computer program within the scope of the claims below may be implemented in any programming language and may be implemented in a computer program product tangibly embodied in a machine-readable storage device for execution by a computer processor.

Method steps of the invention may be performed by one or more processors executing a program tangibly embodied on a computer-readable medium to perform functions of the invention by operating on input and generating output. Suitable processors include e.g., general and special purpose microprocessors. In general, the processor receives (reads) instructions and data from a memory (such as a read-only memory and/or a random access memory) and writes (stores) instructions and data to the memory.

1-22. (canceled)

23. A method of generating media content comprising synchronised video and audio components, the method comprising:
receiving media content captured using a camera function of a user device; wherein the media content has a captured video component and a captured audio component; and further wherein the captured audio component corresponds to audio output by a remote speaker; wirelessly transmitting to the user device an audio signal substantially corresponding to an audio signal input to the remote speaker; and
synchronising the wirelessly transmitted audio signal with the captured video component to generate combined media content in which the captured video component is synchronised with the wirelessly transmitted audio signal.

24. The method according to claim 23, wherein the transmitted audio signal wirelessly transmitted to the user device substantially corresponds to an audio signal output from a mixing console.

25. The method according to claim 23, further comprising wirelessly transmitting synchronisation data to the user device.

26. The method according to claim 25, wherein the synchronisation data comprises a clock synchronisation information to synchronise a clock function at the user device with a system clock function.

27. The method according to claim 24, further comprising providing a networking module for creating a wireless network and wirelessly transmitting the audio signal to the user device over the wireless network, wherein the user device is connected to the wireless network via the networking module.

28. The method according to claim 27, wherein the networking module facilitates wireless communication between the user device and the network; and further wherein the method includes the networking module transmitting the audio signal to the user device.

29. The method according to claim 27, wherein the networking module receives the audio signal output from the mixing console.

30. The method according to claim 27, further comprising generating synchronisation data at the networking module and wirelessly transmitting the synchronisation data to the user device.

31. The method according to claim 23, wherein the method includes wirelessly transmitting the transmitted audio signal to the user device substantially concurrently with the capturing of the media content by the user device.

32. The method according to claim 23, further comprising live streaming the combined media content.

33. The method according to claim 23, wherein the captured audio component of the captured media content is combined with or substantially replaced by the wirelessly transmitted audio signal to generate the combined media content.

34. The method according to claim 23, wherein the synchronising the wirelessly transmitted audio signal includes synchronizing the wirelessly transmitted audio signal with the captured video component and the captured audio component of the captured media content.

35. A non-transitory computer-readable medium comprising computer executable instructions which, when executed by one or more processors cause the one or more processors to perform a method of generating media content according to claim 23.

36. A wearable device configured to communicatively couple with one or more processors comprising instructions executable by the one or more processors, and wherein the one or more processors is operable when executing the instructions to perform the method according to claim 23.

37. A signal processing device for transmitting audio and/or video signals to, and receiving audio and/or video signals from, a wireless network, the signal processing device comprising:
a receiver for receiving audio signals from a mixing console or an audio workstation;
one or more processors configured to generate and associate synchronisation data with the audio signals, the one or more processors being coupled to a network module for providing a wireless network; and
a transmitter for transmitting the audio signals to one or more user devices over the wireless network.

38. The signal processing device according to claim 37, further comprising a clock synchronisation component for establishing a common time base between a master system clock and a clock function of the one or more user devices.

39. An audio workstation comprising the signal processing device of claim 37.

40. A public address system comprising the signal processing device of claim 37.

41. A system for generating media content comprising synchronised video and audio components comprising:
a transmitter configured to wirelessly transmit to one or more user devices an audio signal substantially corresponding to an audio signal input to the remote speaker; and
at least one processor for synchronising the wirelessly transmitted audio signal with a captured video component and/or a captured audio component of captured media content captured by one or more user devices to generate combined media content in which the captured video component is synchronised with the wirelessly transmitted audio signal; wherein the captured audio component corresponds to audio output by a remote speaker.

42. The system according to claim 41, further comprising a clock synchronisation component configured to generate synchronisation data.

43. The system according claim 41, comprising one or more of: a mixing console, an audio workstation, a loudspeaker, an amplifier, a transducer, and one or more wireless access points.

44. The system according to claim 41, further comprising a plurality of the networking modules.

45. The system according to claim 41, comprising a plurality of the user devices.
